(19) United States
(12) Patent Application Publication
(10) Pub. No.: US 2011/0102354 A1
(43) Pub. Date: May 5, 2011

(54) INFORMATION PROCESSING DEVICE, DISPLAY CONTROL METHOD, AND RECORDING MEDIUM

(76) Inventors: Tetsuya Fuyuno, Tokyo (JP); Jun Takikawa, Tokyo (JP)

(21) Appl. No.: 13/000,847

(22) PCT Filed: May 25, 2009
(86) PCT No.: PCT/JP2009/059554

§ 371 Date: Dec. 22, 2010

(30) Foreign Application Priority Data
Jun. 30, 2008 (JP) 2008-169872

(51) Int. Cl. G06F 3/041

(52) U.S. Cl. 345/173

(57) ABSTRACT

An information processing terminal (100) includes: a plurality of display parts (10, 20); a display control part (41) controlling the display operation of the display parts (10, 20); and an operation reception part (42) receiving an operation on display data displayed on the display parts (10, 20). The operation reception part (42) receives the entry of selection of a given area within the display data displayed on one (first) of the display parts. The display control part (41) displays data associated in advance with the data within the selected area indicated by the entry of selection received by the operation reception part (42) on the other (second) display part that is different from the first display part.

### TECHNICAL FIELD

The present invention relates to an information processing device and particularly to an information processing device having multiple display screens, a display control method, and a recording medium.

### BACKGROUND ART

In recent years, cellular phones have been multi-functioned and could be used as a small computer. For example, one of the functions of a cellular phone is data communication capability, in accompaniment with which the cellular phone serves as a device for displaying a book, magazine, or newspaper to browse received data. As electronic devices have increasingly been used as a display device, there has been demand for further improvement in operability and visibility of electronic devices.

Patent Literature 1 to 3 discloses techniques for improving visibility and operability of images displayed on an electronic device. More specifically, Patent Literature 1 discloses a portable electronic device comprising two display units that can mutually be opened/closed in the folding direction and can be integrated in parallel at their sides. On the other hand, Patent Literature 2 discloses an image display control device that is capable of displaying an image around a touched part on the display screen in an enlarged manner to a preset magnification. Furthermore, Patent Literature 3 discloses a display system comprising two display parts connected via radio communication. This display system is capable of displaying on the second display part a part of display data displayed on the first display part in an enlarged manner based on the relative position of the second display part with respect to the first display part.
Patent Literature 1: International Publication Booklet No. WO2005/020046;
Patent Literature 2: Unexamined Japanese Patent Application KOKAI Publication No. 2003-233368; and
Patent Literature 3: Unexamined Japanese Patent Application KOKAI Publication No. 2008-3574.

### SUMMARY OF THE INVENTION

### Problem to be Solved by the Invention

However, the techniques disclosed in the above Patent Literature 1 to 3 still need to be improved in terms of visibility and operability as a display device. Particularly, in Patent Literature 2, although a desired part on the display screen is displayed in an enlarged manner by touching it, the enlarged screen is displayed in place of the original screen; then, visibility is not sufficient. In the Patent Literature 3, the second display part has to be moved relatively to the first display part; then, operation is complex. Furthermore, in the Patent Literature 3, a part superimposed on the first display part is displayed on the second display part in an enlarged manner. The display screen of the first display part is covered by the second display part; then, impaired visibility is a problem.

The present invention is invented in view of the above circumstances and an exemplary object of the present invention is to provide an information processing device, display control method, and recording medium for improving visibility of the display data and operability of the display operation.

### Means for Solving the Problem

The information processing device according to an exemplary aspect of the present invention in order to achieve the above object comprises multiple display parts, a display control means controlling the display operation of the display parts, and an operation reception means receiving an operation on display data displayed on the display parts,

wherein the operation reception means receives the entry of selection of a given area within the display data displayed on one of the display parts, and

the display control means displays data associated in advance with the data within the selected area indicated by the entry of selection received by the operation reception means on another display part that is different from the one display part.

The recording medium according to another exemplary aspect of the present invention records programs that allow a computer comprising multiple display parts to realize a display control means controlling the display operation of the display parts, and an operation reception means receiving an operation on display data displayed on the display parts,

wherein the operation reception means receives the entry of selection of a given area within the display data displayed on one of the display parts, and

the display control means displays data associated in advance with the data within the selected area indicated by the entry of selection received by the operation reception means on another display part that is different from the one display part.

The display control method according to another exemplary aspect of the present invention has an operation reception step of receiving the entry of selection of a given area within the display data displayed on one of multiple display parts, and

a display control step of displaying data associated in advance with the data within the selected area indicated by the entry of selection received in the operation reception step on another display part that is different from the one display part.

### Effect of the Invention

Having the above configuration, the present invention can improve operability of the display operation and visibility of the display data in an information processing device.

### BRIEF DESCRIPTION OF DRAWINGS

FIG. 1 An illustration showing the appearance of the information processing terminal in Embodiment 1;

FIG. 2 A block diagram showing the configuration of the information processing terminal shown in FIG. 1;

FIG. 3 An illustration showing an operation and display of the information processing terminal shown in FIG. 1;

FIG. 4 An illustration showing an operation and display of the information processing terminal shown in FIG. 1;

FIG. 5 An illustration showing an operation and display of the information processing terminal shown in FIG. 1;

FIG. 6 An illustration showing an operation and display of the information processing terminal shown in FIG. 1;

FIG. 7 An illustration showing an operation and display of the information processing terminal shown in FIG. 1;

FIG. 8 An illustration showing an operation and display of the information processing terminal shown in FIG. 1;

FIG. 9 An illustration showing an operation and display of the information processing terminal shown in FIG. 1;

FIG. 10 An illustration showing an operation and display of the information processing terminal shown in FIG. 1;

FIG. 11 An illustration showing an operation and display of the information processing terminal shown in FIG. 1;

FIG. 12 A flowchart showing the action of the information processing terminal shown in FIG. 1;

FIG. 13 An illustration showing the appearance of the information processing terminal in Embodiment 2;

FIG. 14 An illustration showing a display of the information processing terminal shown in FIG. 13; and

FIG. 15 An illustration showing the appearance and an operation and display of the information processing terminal in Embodiment 3.

### BEST MODE FOR CARRYING OUT THE INVENTION

The information processing device according to an exemplary aspect of the present invention comprises multiple display parts, a display control means controlling the display operation of the display parts, and an operation reception means receiving an operation on display data displayed on the display parts,

wherein the operation reception means receives the entry of selection of a given area within the display data displayed on one of the display parts, and

the display control means displays data associated in advance with the data within the selected area indicated by the entry of selection received by the operation reception means on another display part that is different from the one display part.

Furthermore, in the above information processing device, the display control means displays data having the same contents as the data within the selected area indicated by the entry of selection received by the operation reception means on the other display part as the data associated in advance with the data within the selected area.

Furthermore, in the above information processing device, the display control means displays the data having the same contents as the data within the selected area on the other display part in an enlarged manner compared with the display state on the one display part.

Furthermore, in the above information processing device, the display control means displays higher image quality data having the same contents as the data within the selected area on the other display part in an enlarged manner compared with the display state on the one display part.

Furthermore, in the above information processing device, the display control means displays the data having the same contents as the data within the selected area on the other display part in a data format different from the data format displayed on the one display part.

Furthermore, in the above information processing device, when the data having the same contents as the data within the selected area contain character data, the display control means displays the character data in a size different from the display size on the one display part.

Furthermore, in the above information processing device, the operation reception means receives the entry of change of the selected area within the display data displayed on one of the display parts, and

the display control means displays data associated in advance with the data within the changed selected area in accordance with the change of selected area indicated by the entry of change received by the operation reception means on another display part that is different from the one display part.

Furthermore, in the above information processing device, the operation reception means receives a given operation instruction on the display data displayed on the one display part and the other display part, and

a data processing means executing processing corresponding to the operation instruction received by the operation reception means with respect to the display data displayed on the one display part and the other display part is provided.

Furthermore, in the above information processing device, when the data within the selected area indicated by the entry of selection received by the operation reception means contain address information, the display control means accesses a data storage region identified by the address information, acquires data within the data storage region, and displays the acquired data on the other display part as the data associated in advance with the data within the selected area.

Furthermore, in the above information processing device, the display control means displays selected range information that allows the selected area to be identified on the one display part.

The above-described information processing device of the present invention first displays given display data on one provided display part. Then, as the user enters the selection of a part of the display data displayed on the one display part, the information processing device displays data corresponding to the data within the selected area in advance, for example data having the same contents as the data within the selected area on another display part. Here, the information processing device displays data on the other display part in various fashions such as enlarged display, enlarged display of higher image quality data, display in a different data format, and display in a different character size. Furthermore, when the selected range is subsequently changed, the information processing device displays on the other display part data corresponding to the data within the changed selected range in accordance with the change of selected range. Furthermore, the information processing device executes given processing on the data within the selected range in accordance with the operation instruction entered with respect to the data within the selected range.

As described above, the information processing device continues to display the original display data on one display part and further displays on another display part data corresponding to the selected area of the display data. Therefore, the user can view the entire display data and simultaneously view a partial area of it on another display part with simple operations. Consequently, operability of the display operation and visibility of the display data can be improved.

Furthermore, in the above information processing device, the multiple display parts are two display parts engaged in the manner that they can be viewed simultaneously, and

the display control means displays, on the other display part, data associated in advance with the data within a selected area indicated by the entry of selection received by the operation reception means among the display data displayed on one of the display parts.

Furthermore, in the above information processing device, the two display parts are coupled in the manner that they are capable of opening/closing or sliding.

Furthermore, in the above information processing device, the display parts consist of a touch panel and are capable of receiving touch input from outside, and

the operation reception means receives the entry of selection of a given area within the display data displayed on the display parts that is done by touch input on the display parts.

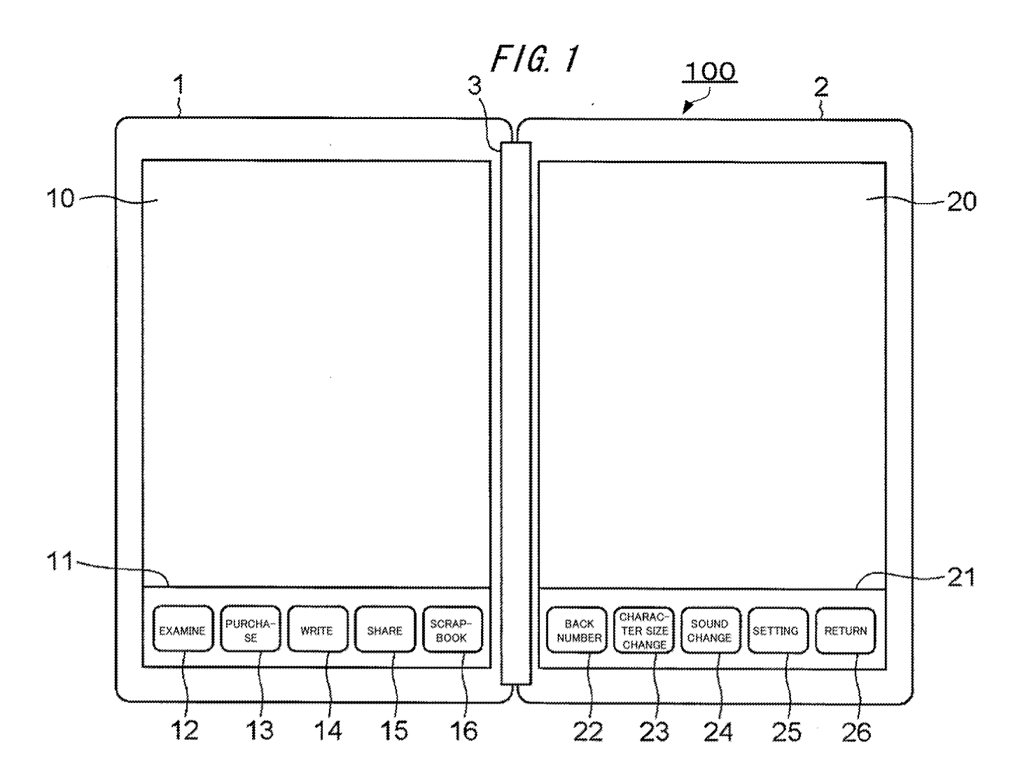

Embodiments of the information processing device, display control method, and recording medium according to the present invention will be described hereafter with reference to FIGS. 1 to 15.

### Embodiment 1

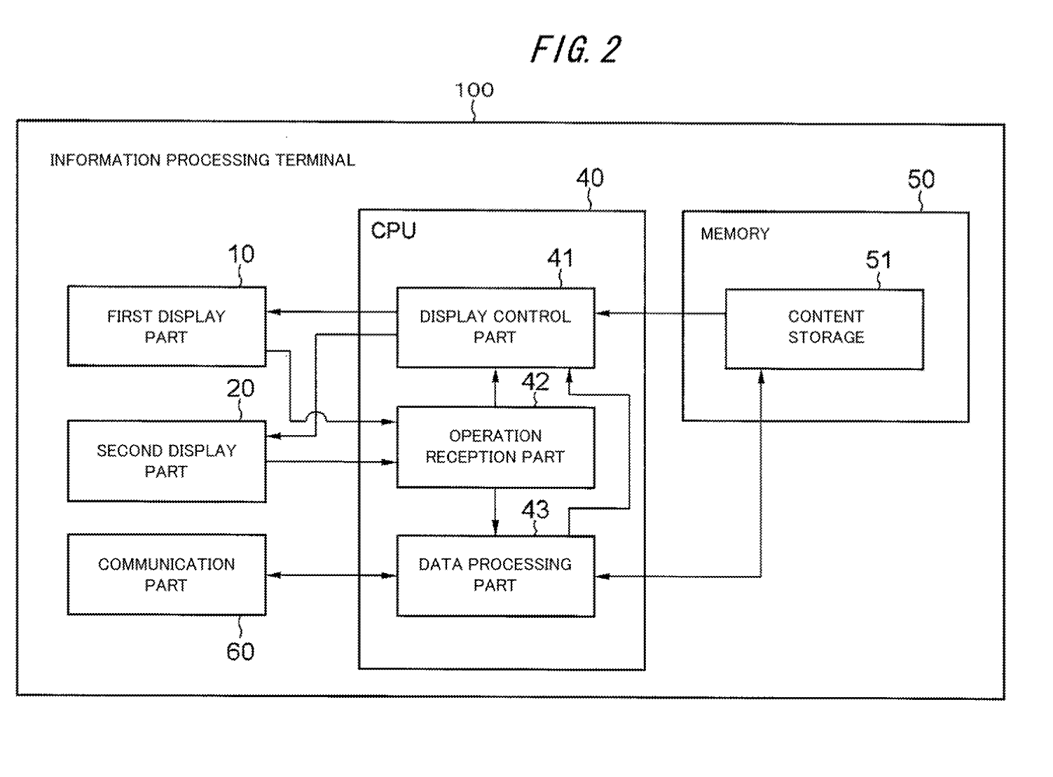

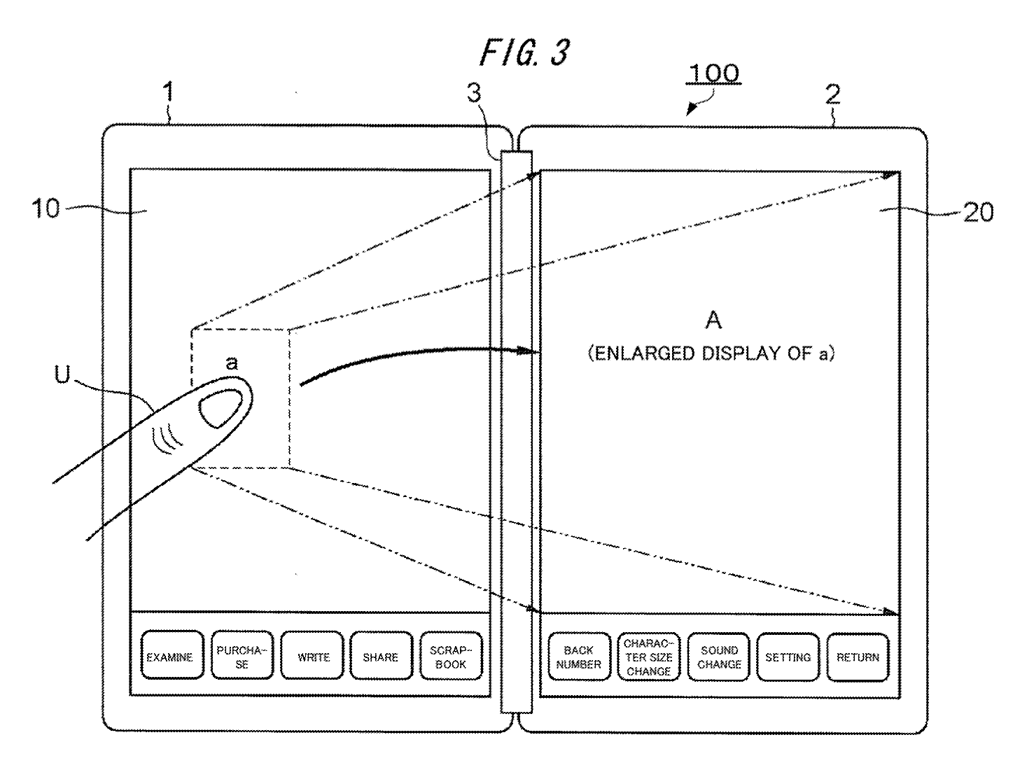

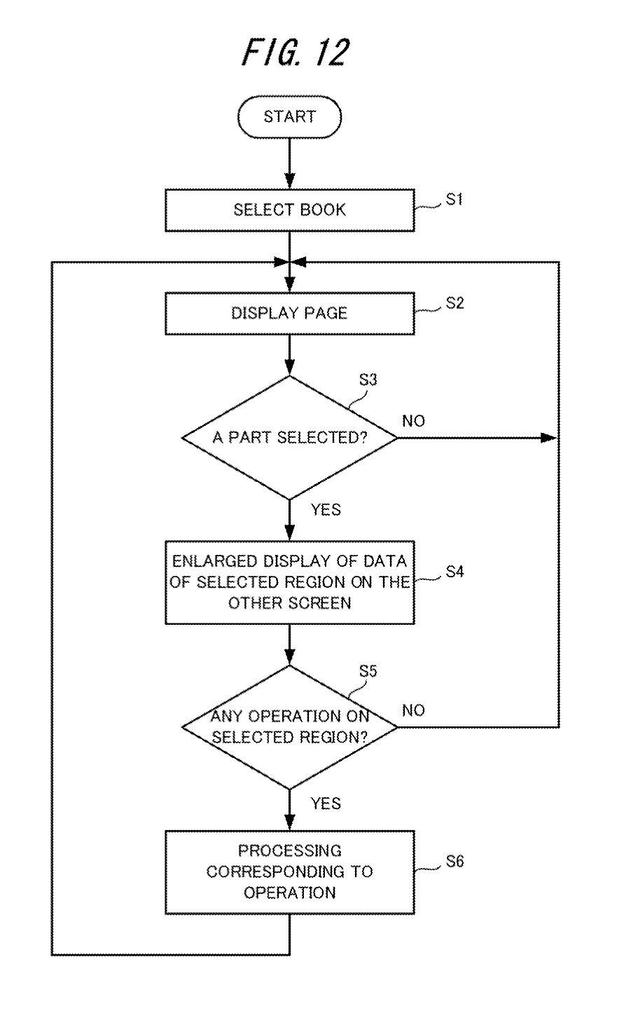

Embodiment 1 of the present invention will be described with reference to FIGS. 1 to 12. FIG. 1 is an illustration showing the appearance of an information processing terminal 100 of this embodiment. FIG. 2 is a functional block diagram showing the configuration of the information processing terminal 100. FIGS. 3 to 11 are illustrations showing operations and displays of the information processing terminal 100. FIG. 12 is a flowchart showing the action of the information processing terminal 100.

[Structure]

The information processing terminal 100 (an information processing device) of this embodiment is a folding-type information processing terminal having a first enclosure 1 and a second enclosure 2 that are coupled to each other via a hinge part 3 so that they can be opened/closed on an arbitrary basis. The first enclosure 1 comprises a first display part 10 and the second enclosure 2 comprises a second display part 20. Therefore, when the information processing terminal 100 is not in use, the first and second enclosures 1 and 2 are folded with the first and second display parts 10 and 20 being inside. On the other hand, the first and second enclosures 1 and 2 are opened for use so that the first and second display parts 10 and 20 can be viewed at the same time. The first and second display parts 10 and 20 each consist of a touch panel. Upon touch input by pressing with a finger or stylus pen from outside, the input is received.

The information processing terminal 100 incorporates, as shown in FIG. 2, a CPU 40 as an processing unit, a memory 50 as a storage, and a communication part 60 realizing radio communication. In other words, the information processing terminal 100 has the basic configuration as a computer.

More specifically, the CPU 40 comprises a display control part 41, an operation reception part 42, and a data processing part 43, which are configured by installing programs in the CPU 40. The memory 50 comprises a content storage 51. These components will be described in detail later.

The display control part 41 (the display control means) has the function of controlling display operation of the first and second display parts 10 and 20 as the basic function. In other words, the display control part 41 reads and displays the content data stored in the content storage 51 of the memory 50 on the main display areas (the regions) that are the major parts of the first and second display parts 10 and 20. Alternatively, the display control part 41 displays on the main display areas (regions) of the first and second display parts 10 and 20 data acquired by the data processing part 43 from another computer on the network via the communication part 60 as described later. Furthermore, the display control part 41 displays multiple operation buttons 12 to 16 and 22 to 26 in operation button display regions 11 and 21 provided at the bottoms of the display parts 10 and 20.

Furthermore, the display control part 41 displays given data on the display parts 10 and 20 in accordance with the operation instruction the operation reception part 42 receives from the user as described later or in accordance with results of processing by the data processing part 43. Details of the processing will be described later.

The operation reception part 42 (the operation reception means) receives the entry of operation from the user as the basic function. Particularly, in the information processing terminal 100 of this embodiment, the operation reception part 42 receives touch input on the first and second display parts 10 and 20 each consisting of a touch panel as the entry of operation from the user. For example, the user touches the display data displayed on the display parts 10 and 20 from above the display parts 10 and 20 to enter the selection of a specific area (range) of the display data touched and the operation reception part 42 receives the entry of selection of the selected range. Furthermore, the user touches one of the operation buttons 12 to 16 and 22 to 26 displayed in the operation button display regions 11 and 21 to enter it and the operation reception part 42 receives the entry of selection of the operation button.

The data processing part 43 (the data processing means) executes processing for making data to be displayed by the display control part 41 available for display on the display parts 10 and 20. Furthermore, the data processing part 43 executes processing corresponding to the operation content of the operation button of which the selection is received by the operation reception part 42 with respect to the display data. Detailed contents of specific processing will be described later.

Functions of the display control part 41, operation reception part 42, and data processing part 43 will be described in further detail hereafter. As shown in FIG. 3, with respect to the display data displayed on the first display part 10, the user touches the display part 10 with a finger to select a specific area that is a part within the display data (see the reference code U) and the operation reception part 42 identifies the selected range within the display data. For example, in the case shown in FIG. 3, the operation reception part 42 identifies an area around the part the user has touched with a finger (see the reference code U) as a selected range a.

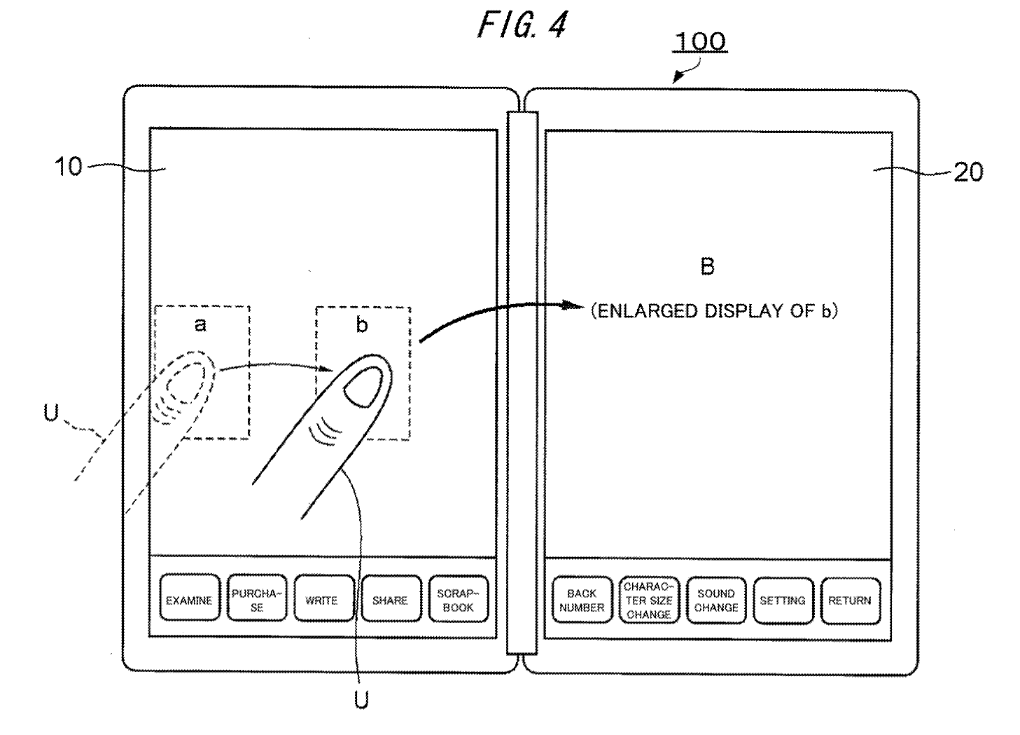

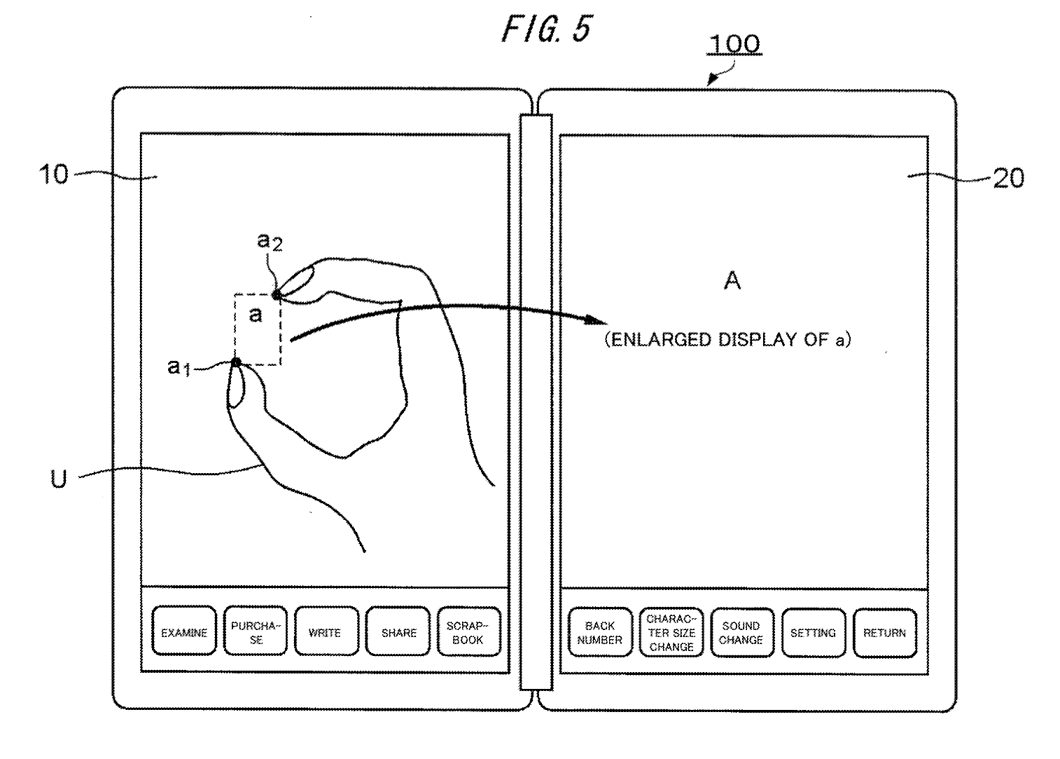

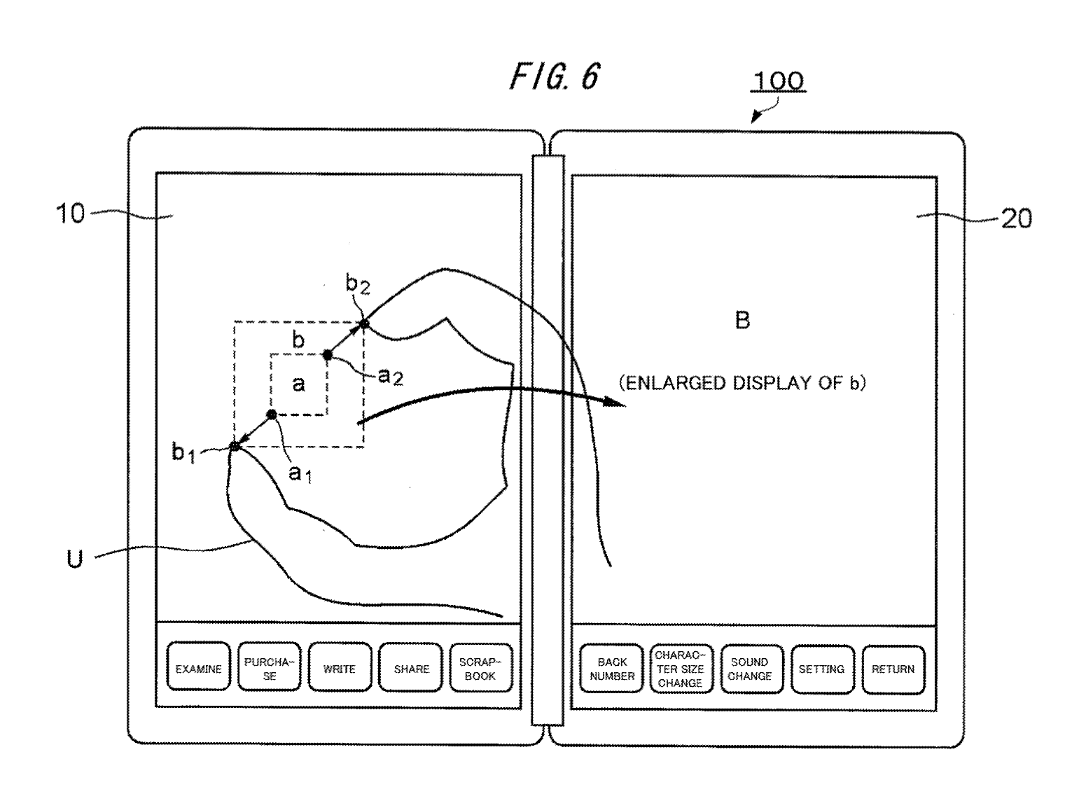

Here, for example, the operation reception part 42 receives a preset range around the touched point as the selected range a. If the user moves the position of the selected range a by moving the finger U touching it as shown in FIG. 4 after the selection of the selected range a is received, then, a selected range b after the move is selected and the operation reception part 42 receives the selection. Here, how the selected range a is identified by the operation reception part 42 is not restricted to the above fashion. For example, as shown in FIG. 5, a rectangular area having a diagonal defined by two points (a1, a2) touched by two fingers can be selected as a selected range a. In such a case, after the selected range a is identified, the user can increase or decrease the distance between the two fingers touching it as shown in FIG. 6 (see the reference code U). Then, the selected range a changes in size and a rectangular area b having a diagonal defined by two changed points (b1, b2) is selected.

Then, as described above, with the operation reception part 42 receiving the operation of specifying the selected range, the display control part 41 displays data associated in advance with the data within the selected range on another display part that is different from the display part on which the selected range is selected. For example, in the cases of FIGS. 3 and 5, the selected range a within the display data displayed on the first display part 10 is displayed on the entire second display part 20 in an enlarger manner compared with the display state on the first display part 10 (see the reference code A and thick arrowed line). Furthermore, when the selected range a within the display data displayed on the first display part 10 is moved or changed in size as shown in FIGS. 4 and 6, the changed selected range b is displayed on the entire second display part 20 in an enlarged manner (see the reference code B and thick arrowed line).

Here, the display control part 41 uses the data of the selected range a or b selected on the first display part 10 as they are as data for displaying the selected range A or B on the second display part 20 in an enlarged manner. Here, the display control part 41 can acquire other data for the enlarged display on the second display part 20 as long as the data has the same contents as the data of the selected range a or b selected on the first display part 10. For example, data having the same contents as the display data displayed on the first display part 10 but having a higher quality (high image quality) can separately be stored in the content storage 51 in advance. Then, the display control part 41 can read and display on the second display part 20 the high quality data of the same contents (same range) as the data of the selected range a or b selected on the first display part 10. Furthermore, the display control part 41 can acquire and display on the second display part 20 high quality data of the same range as the selected range a or b from another computer on the network via the data processing part 43 and communication part 60.

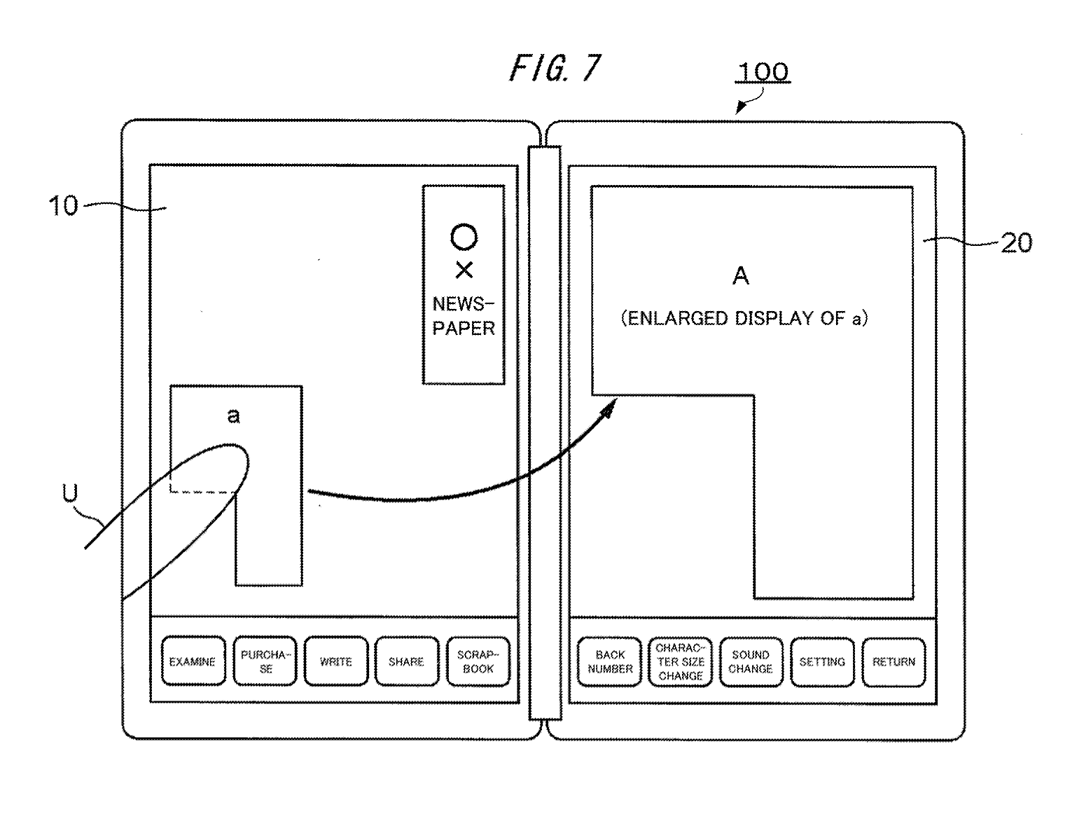

Furthermore, when a section is preset within the display data and the section is selected by the user, the operation reception part 42 identifies the selected section as a selected range. For example, when a section such as an individual article is preset within the display data such as newspaper data displayed on the display parts 10 and 20 as shown in FIGS. 7, 8, and 10, the operation reception part 42 identifies the preset section (a or d) containing the point touched by the user with a finger U as a selected range.

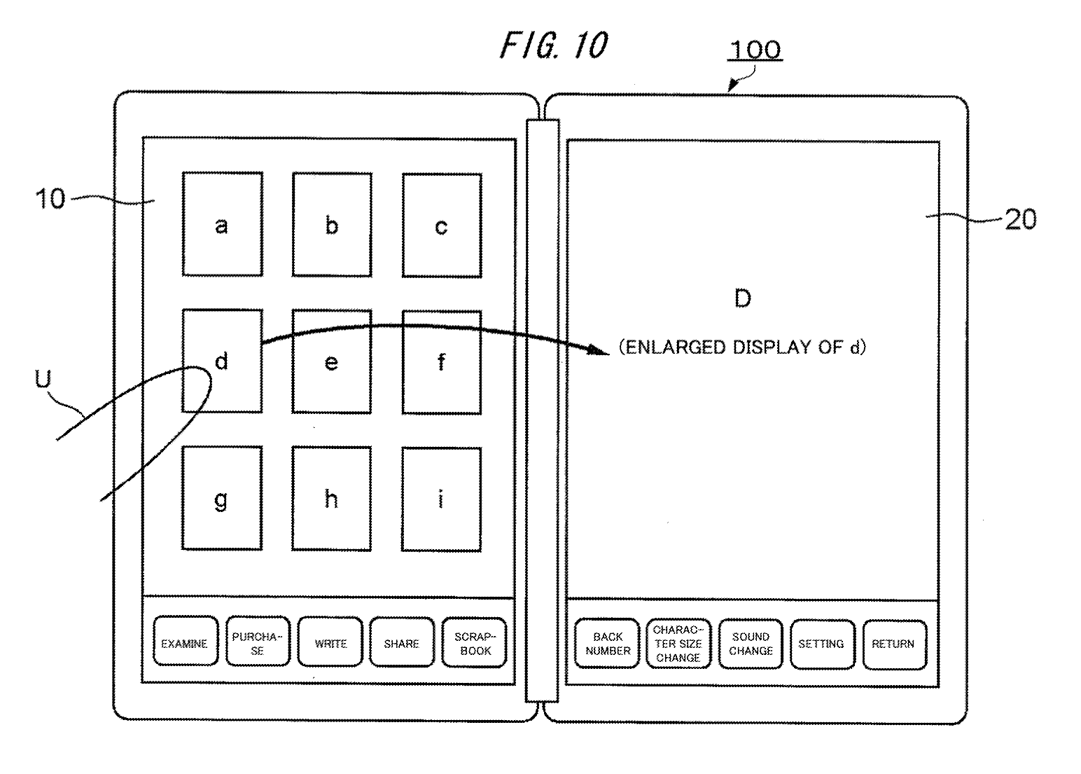

Then, with the operation reception part 42 receiving the operation of specifying the selected range, as described above, the display control part 41 displays data associated in advance with the data within the selected range on another display part that is different from the display part on which the selected range is selected. For example, in the cases of FIGS. 7 and 10, the selected range a or d within the display data displayed on the first display part 10 is displayed on the entire second display part 20 in an enlarged manner compared with the display state on the first display part 10 (see the reference code A or D). Here, also in this case, the display control part 41 can use the data of the selected range a or d as they are to display the data on the second display part 20 in an enlarged manner as described above. Alternatively, the display control part 41 can acquire and display on the second display part 20 high quality (high image quality) data of the same contents (same range) as the data of the selected range a or d.

As described above, when the display control part 41 displays an enlarged view on the second display part 20, the display control part 41 displays some indication on the first display part 10 so that the selected range a or d on the display part 10 that is the original data of the enlarged view on the second display part 20 can be identified. For example, the display control part 41 displays the contour of the selected range a or d in a thick line or blinks the contour of the selected range a or d.

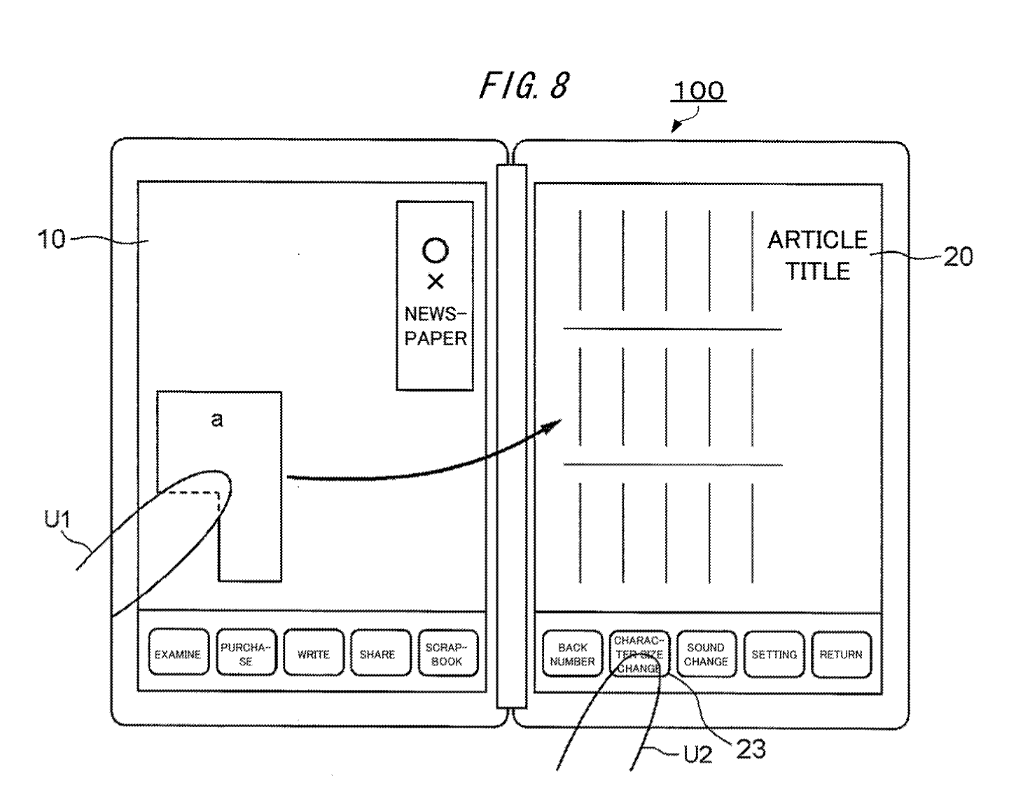

Furthermore, in another exemplary display, the display control part 41 displays on the second display part 20 data having the same contents but having a different data format from the data format displayed on the first display part 10 as data associated in advance with the data within the selected range as shown in FIG. 8. More specifically, in the case of FIG. 8, data of an image format are displayed on the first display part 10. When the selected range a is selected, the display control part 41 displays on the second display part 20 data of a character format having the same contents as the data within the selected range a. Here, the display control part 41 may convert the data within the selected range a to acquire data of a different format to be displayed on the second display part 20. In such a case, for example, the data processing part 43 executes a given character recognition process to create data of a character format from data of an image format within the selected range a. Alternatively, the display control part 41 can acquire data of a character format within the selected range a from the content storage 51 or another computer on the network.

Here, it is assumed that the user selects a selected range a displayed on the first display part 10 (see the reference code U1) and the user touches a button “character size change” 23 (see the reference code U2) while character data are displayed on the second display part 20 as shown in FIG. 8. Then, the operation reception part 42 receives the size change instruction with regard to the character data displayed on the second display part 20. Then, the display control part 41 accordingly changes, for example increases the size of character data displayed on the display part 20.

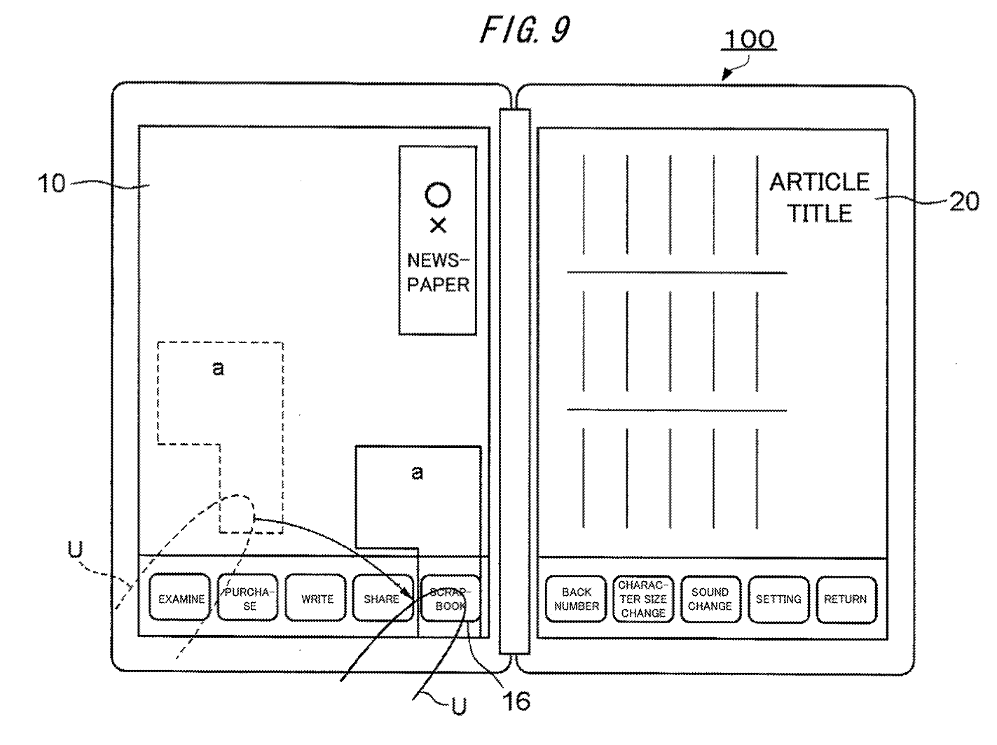

Furthermore, if the user touches a button “scrapbook” 16 as shown in FIG. 9, the operation reception part 42 receives this operation instruction. Then, according to this operation instruction, the data processing part 43 executes processing on the data displayed on the display parts 10 and 20. For example, in the case shown in FIG. 9, after the button “scrapbook” 16 is touched, the selected range a is moved (dragged) onto the button “scrapbook” 16 (see the reference code U) and the data processing part 43 stores the data within the selected range a in the content storage 51. Here, the data processing part 43 can store the data within the dragged selected range a as image data or convert them to data of a character format before storing them as displayed on the second display part 20.

Then, the display control part 41 can display a list of data stored as described above on the first display part 10 as indicated by reference codes a to i in FIG. 10 so that they can be selected. Then, when the user touches any of the stored data (see the reference code U), the operation reception part 42 selects the entire data touched as a selected range d and the display control part 41 displays the data in the selected range d similarly on the second display part 20 in an enlarged manner.

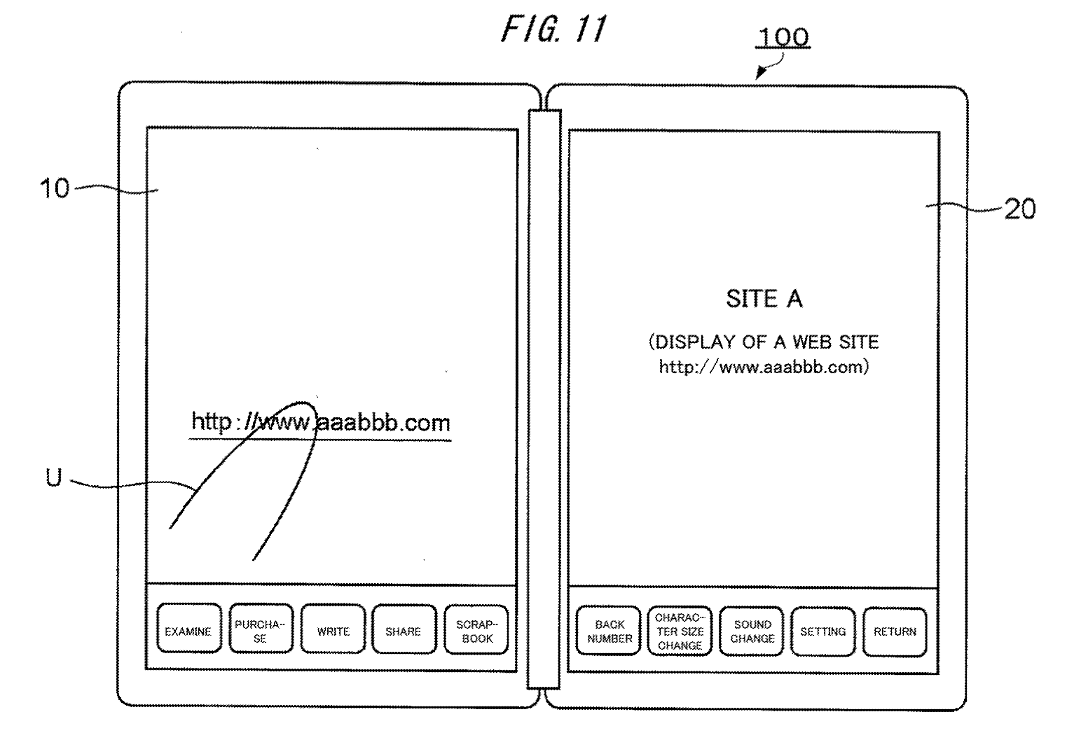

In the case of FIG. 11, the data displayed on the first display part 10 contains address information such as a URL (uniform resource locator) at the area touched by the user. In this case, first, the operation reception part 42 identifies the address information contained in the touched area and informs the display control part 41 of the address information. Then, in collaboration with the data processing part 43, the display control part 41 accesses a data storage region such as a Web site identified by the address information to acquire data within the data storage region (Web site). Then, the display control part 41 displays the acquired data on the second display part 20 that is different from the first display part 10 on which the address information is displayed.

[Action]

Action of the information processing terminal 100 having the above configuration will be described hereafter with reference to the flowchart in FIG. 12. First, the user operates the information processing terminal 100 to select a book (content) to be displayed (Step S1). Then, the display control part 41 of the information processing terminal 100 acquires the selected content such as a newspaper, magazine, and book from the content storage 51 and displays it two pages at a time on the display parts 10 and 20 (Step S2). The selected content may be acquired by the data processing part 43 from another computer via the communication part 60.

Then, when the user wishes to view details of a part of the page (display data) displayed, he/she touches a partial area on the display part on which the partial area is displayed. Then, the operation reception part 42 of the information processing terminal 100 receives the selection of a selected range (Step S3: Yes, the operation reception step). In response to the reception, the display control part 41 displays data corresponding to the selected range on another display part that is different from the display part on which the selected range is displayed (Step S4: the display control step).

Here, the display control part 41 of the information processing terminal 100 displays on the display part 20 data having the same contents as the selected range a or d displayed on the display part 10 in an enlarged manner as described with reference to FIGS. 3, 5, 7, and 10 (A or D). Furthermore, the display control part 41 displays on the display part 20 data A having the same content as the selected range a displayed on the first display part 10 but having a different data format as shown in FIG. 8. Furthermore, the display control part 41 displays on the second display part 20 data of the access destination indicated by the address information contained in the selected range displayed on the first display part 10.

Then, when the user enters an operation instruction on the data within the selected range as described above (Step S5: Yes), the information processing terminal 100 executes data processing or display processing corresponding to the operation (Step S6). For example, as shown in FIGS. 4 and 6, when the position of the selected range a or the range itself is changed on the display part 10, the display control part 41 displays on the second display part 20 data B corresponding to the changed selected range b in accordance with the change of the selected range a. Furthermore, as shown in FIG. 8, when the button “character size change” 23 is touched, the display control part 41 displays character data displayed on the second display part 20 in a changed character size. Furthermore, as shown in FIG. 9, when the selected range a is dragged onto the button “scrapbook” 16, the data processing part 43 stores the data of the selected range a.

As described above, the information processing terminal 100 of the present invention continues to display the original display data on one display part and displays on the other display part data corresponding to the selected area of the display data. Therefore, the user can view the entire display data on the one display part and simultaneously view a part of it on the other display part with simple operations. Consequently, operability of the display operation and visibility of the display data can be improved.

In the above information processing terminal 100, two display parts 10 and 20 are coupled by a hinge part 3 so that they can be opened/closed. The information processing terminal (device) 100 of the present invention is not confined to this structure. For example, two display parts 10 and 20 can be coupled slidably or provided separately as described later.

### Embodiment 2

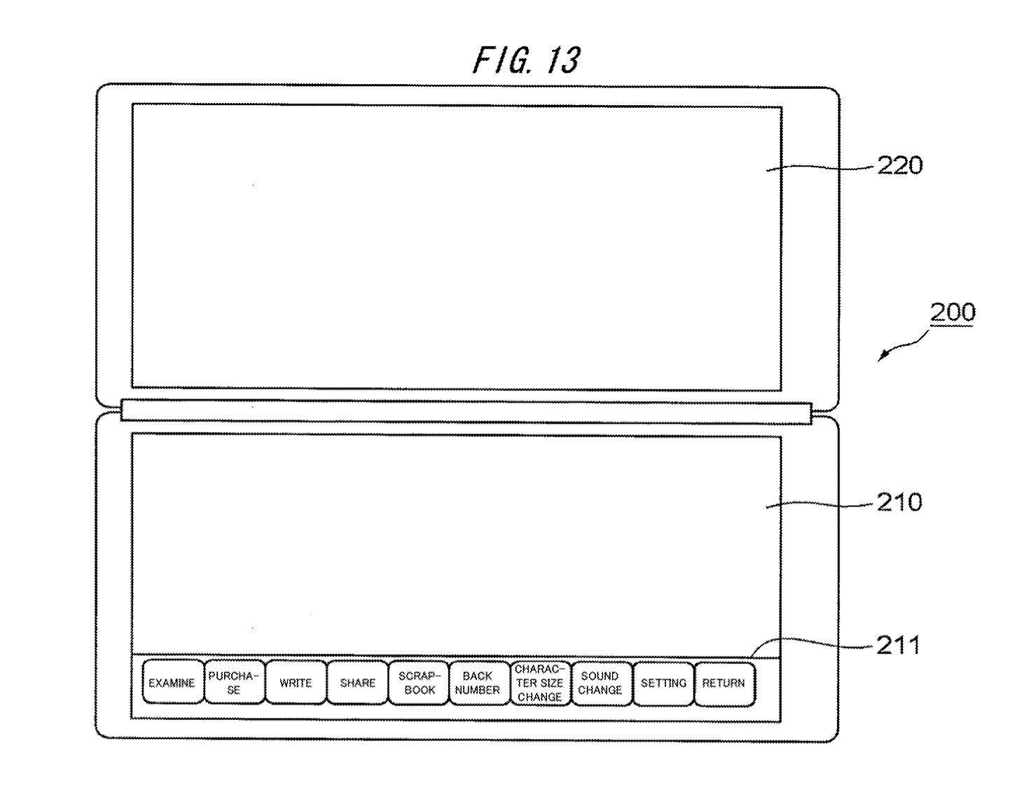

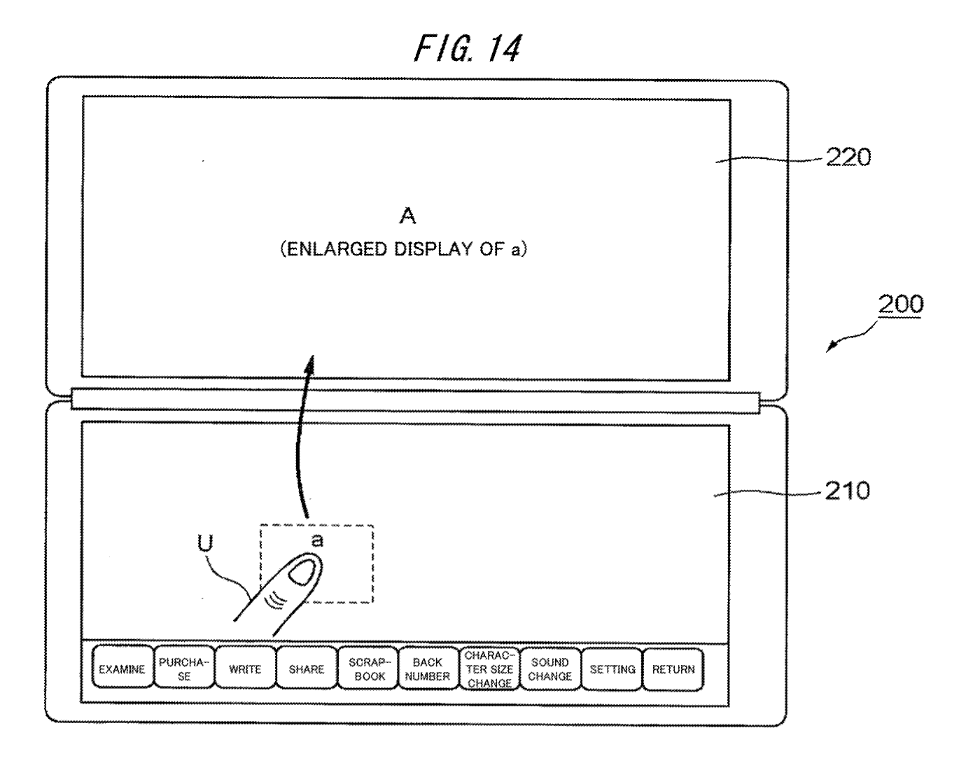

Embodiment 2 of the present invention will be described hereafter with reference to FIGS. 13 and 14. FIG. 13 is an illustration showing the appearance of an information processing terminal 200 of this embodiment and FIG. 14 is an illustration showing an operation and display of the information processing terminal 200.

The information processing terminal 200 (an information processing device) of this embodiment is a folding-type information processing terminal having a first display part 210 and a second display part 220 that are coupled to each other via a hinge part so that they can be opened/closed on an arbitrary basis. Structurally, the information processing terminal 200 is rotated by 90 degrees from the information processing terminal 100 in the above Embodiment 1. In other words, the information processing terminal 200 of this embodiment has the first and second display parts 210 and 220 one above the other, instead of side by side as in Embodiment 1. Furthermore, the information processing terminal 200 has an operation button display region 211 collectively located at the bottom of the first display part 210. Here, the information processing terminal 200 has the same internal configuration as the one shown in FIG. 2.

Therefore, for example, as shown in FIG. 14, when display data are displayed on the first display part 210 and the user U touches the first display part 10 to select a given area that is a part within the display data (see the reference code U), the information processing terminal 200 identifies a selected range a within the display data. Then, the information processing terminal 200 displays data associated in advance with the data within the selected range a on the entire display part 220 that is another display part different from the first display part 210 on which the selected range a is selected in an enlarged manner. In FIG. 14, the information processing terminal 200 displays the selected range on the other display part in an enlarged manner by way of example. However, as described in Embodiment 1, the information processing terminal 200 of this embodiment can also execute other processing as in Embodiment 1 such as displaying on the other display part in a different data format.

Here, the information processing terminal 200 of this embodiment can simply consist of the same terminal as the information processing terminal 100 described in Embodiment 1. In other words, the information processing terminal 200 can be realized by the information processing terminal 100 being rotated by 90 degrees; then, the information processing terminal 100 detects it using built-in acceleration sensors, automatically rotates the displays of the display data on the first and second display parts 10 and 20 by 90 degrees in the same direction, and displays the operation button display region at the changed position.

### Embodiment 3

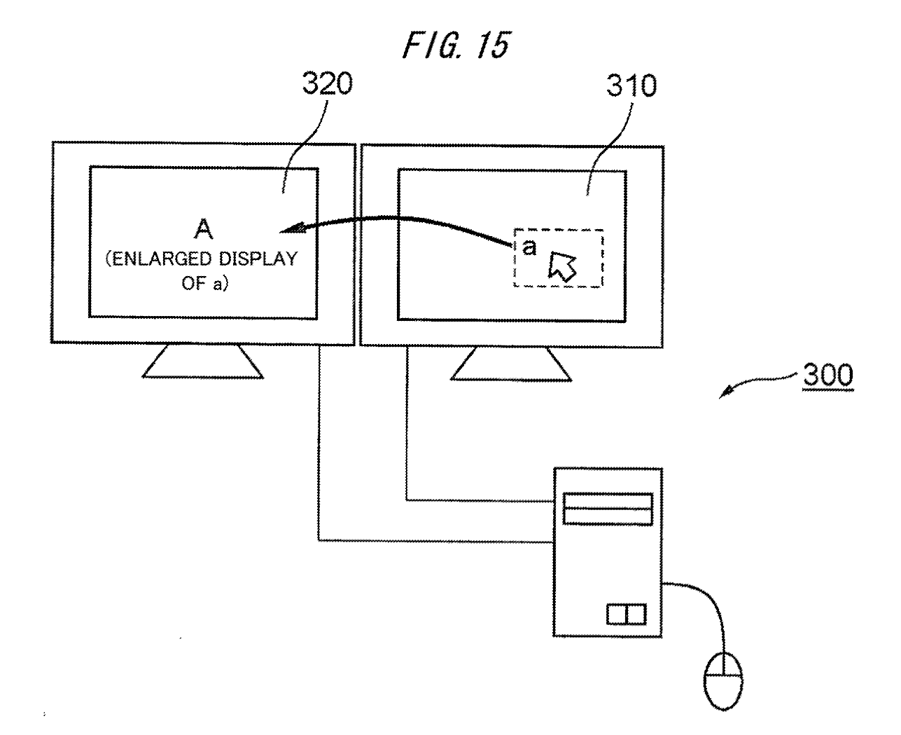

Embodiment 3 of the present invention will be described hereafter with reference to FIG. 15. FIG. 15 is an illustration showing the appearance of an information processing device 300 of this embodiment and an operation and display of the information processing device 300.

The information processing device 300 of this embodiment is a dual display type computer comprising a first display part 310 and a second display part 320 that are connected. The information processing device 300 has the same internal configuration as the one shown in FIG. 2.

Therefore, for example, when display data are displayed on the first display part 310 and the user selects a given area that is a part within the display data on the first display part 310 using an operation device such as a mouse as shown in FIG. 15, the information processing device 300 identifies a selected range a within the display data. Then, the information processing device 300 displays data associated in advance with the data within the selected rage a on the entire display part 320 that is another display part different from the first display part 310 on which the selected range is selected in an enlarged manner. In FIG. 15, the information processing device 300 displays the selected range on the other display part in an enlarged manner by way of example. However, as described in Embodiment 1, the information processing device 300 of this embodiment can also execute other processing as in Embodiment 1 such as displaying on the other display part in a different data format.

As described above, the present invention is not confined to an information processing terminal having two display parts coupled to each other so that they can be opened/closed. The present invention is applicable to an information processing device having two display pairs provided separately.

In the above description, the present invention is applied to an information processing terminal (device) having two display parts by way of example. The information processing terminal (device) does not necessarily comprise two display parts. In other words, the present invention is applicable to an information processing terminal (device) having three or more display parts. In such a case, the information processing terminal (device) displays data corresponding to the selected range on another display part that is different from the display part on which the selected range is selected. In this way, the user can view the entire display data on one display part and simultaneously view a part thereof on another display part with simple operations. Consequently, operability of the display operation and visibility of the display data can be improved.

The present invention is based on the Japanese Patent Application No. 2008-169872 filed on Jun. 30, 2008, the Specification, Scope of Claims, and Drawings of which are entirely incorporate herein by reference.

### INDUSTRIAL APPLICABILITY

The present invention is applicable to an information processing device having multiple display parts such as folding-type portable information processing terminals and has industrial applicability.

### LEGEND

1 first enclosure
2 second enclosure
3 hinge part
10, 210, 310 first display part
20, 220, 320 second display part
40 CPU
41 display control part
42 operation reception part
43 data processing part
50 memory
51 content storage
60 communication part
100, 200 information processing terminal
300 information processing device

1. An information processing device comprising multiple display parts, a display control part controlling the display operation of the display parts, and an operation reception part receiving an operation on display data displayed on said display parts,
wherein said operation reception part receives the entry of selection of a given area within the display data displayed on one of said display parts, and
said display control part displays data associated in advance with the data within the selected area indicated by the entry of selection received by said operation reception part on another display part that is different from said one display part.

2. The information processing device according to claim 1 wherein said display control part displays data having the same contents as the data within the selected area indicated by the entry of selection received by said operation reception part on said other display part as said data associated in advance with the data within the selected area.

3. The information processing device according to claim 2 wherein said display control part displays said data having the same contents as the data within the selected area on said other display part in an enlarged manner compared with the display state on said one display part.

4. The information processing device according to claim 2 wherein said display control part displays higher image quality data having the same contents as said data within the selected area on said other display part in an enlarged manner compared with the display state on said one display part.

5. The information processing device according to claim 2 wherein said display control part displays said data having the same contents as the data within the selected area on said other display part in a data format different from the data format displayed on said one display part.

6. The information processing device according to claim 5 wherein when said data having the same contents as the data within the selected area contain character data, said display control part displays the character data in a size different from the display size on said one display part.

7. The information processing device according to claim 1 wherein said operation reception part receives the entry of change of said selected area within the display data displayed on one of said display parts, and
said display control part displays data associated in advance with the data within the changed selected area in accordance with the change of selected area indicated by the entry of change received by said operation reception part on another display part that is different from said one display part.

8. The information processing device according to claim 1 wherein said operation reception part receives a given operation instruction on the display data displayed on said one display part and said other display part, and
a data processing part executing processing corresponding to the operation instruction received by said operation reception part with respect to the display data displayed on said one display part and said other display part is provided.

9. The information processing device according to claim 1 wherein when the data within the selected area indicated by the entry of selection received by said operation reception part contain address information, said display control part accesses a data storage region identified by the address information, acquires data within the data storage region, and displays the acquired data on said other display part as said data associated in advance with the data within the selected area.

10. The information processing device according to claim 1 wherein said display control part displays selected range information that allows said selected area to be identified on said one display part.

11. The information processing device according to claim 1 wherein said multiple display parts are two display parts engaged in the manner that they can be viewed simultaneously, and
said display control part displays, on the other display part, data associated in advance with the data within a selected area indicated by the entry of selection received by said operation reception part among the display data displayed on one of said display parts.

12. The information processing device according to claim 11 wherein said two display parts are coupled in the manner that they can be opened/closed or slid.

13. The information processing device according to claim 1 wherein said display parts consist of a touch panel and are capable of receiving touch input from outside, and
said operation reception part receives the entry of selection of a given area within the display data displayed on said display parts that is done by touch input on said display parts.

14. A computer-readable recording medium in which recorded are programs that allow a computer comprising multiple display parts to realize a display control part controlling the display operation of the display parts, and an operation reception part receiving an operation on display data displayed on said display parts,
wherein said operation reception part receives the entry of selection of a given area within the display data displayed on one of said display parts, and
said display control part displays data associated in advance with the data within the selected area indicated by the entry of selection received by said operation reception part on another display part that is different from said one display part.

15. The recording medium according to claim 14 wherein said display control part displays data having the same contents as the data within the selected area indicated by the entry of selection received by said operation reception part on said other display part as said data associated in advance with the data within the selected area.

16. A display control method having an operation reception step of receiving the entry of selection of a given area within the display data displayed on one of multiple display parts, and
a display control step of displaying data associated in advance with the data within the selected area indicated by the entry of selection received in said operation reception step on another display part that is different from said one display part.

17. The display control method according to claim 16 wherein said display control step consists of displaying data having the same contents as the data within the selected area indicated by the entry of selection received in said operation reception step on said other display part as said data associated in advance with the data within the selected area.
